(19) United States
(12) Patent Application Publication
(10) Pub. No.: US 2007/0041520 A1
(43) Pub. Date: Feb. 22, 2007

(54) Exchange system, telephone exchange apparatus, and voice message notification method

(75) Inventor: Yoshihito Nagano, Tokyo (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/431,494

(22) Filed: May 10, 2006

(30) Foreign Application Priority Data
May 19, 2005 (JP) P2005-146950

(51) Int. Cl. H04M 11/00

(52) U.S. Cl. 379/88.13

(57) ABSTRACT

When an incoming call directed to an extension terminal arrives from an external telephone terminal and the incoming call signal is transferred to a voice mail unit, a voice message detection section of the voice mail unit detects the presence or absence of a voice message from the caller before the extension terminal is notified that recording of the voice message from the caller is started. When the voice message from the caller is detected, a central control section informs the extension terminal that the voice message is detected.

### CROSS-REFERENCE TO RELATED APPLICATIONS

This application is based upon and claims the benefit of priority from Japanese Patent Application No. 2005-146950, filed on May 19, 2005, the entire contents of which are incorporated herein by reference.

### BACKGROUND

1. Field

One embodiment relates to an exchange system including a voice mail unit for storing a voice message from a caller, a telephone exchange apparatus, and a voice message notification method.

2. Description of the Related Art

Hitherto, a telephone exchange apparatus such as a PBX (Private Branch Exchange) or a key telephone system main unit has been often used, for example, in an office building and a branch office. The telephone exchange apparatus, to which a voice mail unit is connected, has a function of transferring a call incoming to one of accommodated extensions from an external line to the voice mail unit, for example, if the extension is busy or a person does not pick up the receiver because he or she leaves his or her seat or for any other reason.

The voice mail unit has a function of storing messages from telephones in a plurality of mail boxes, for example.

When starting to record a message in any mail box of the voice mail unit, the telephone exchange apparatus displays a message indicating recording on an LCD (Liquid Crystal Display) of the extension corresponding to the mail box or lights or blinks an LED (Light Emitting Diode). (For example, refer to JP-A-10-126506, a corresponding U.S. patent publication No. of which is U.S. Pat. No. 5,956,389 A1.) Therefore, the user of the extension can recognize that the voice message from the caller is recorded in the voice mail unit.

However, the telephone exchange apparatus notifies the extension corresponding to the mail box of recording at the recording start time regardless of whether or not a voice message from the caller exists.

Thus, whenever a recording start command in the mail voice unit is given, the telephone exchange apparatus must notify the corresponding extension that recording is started, and increases in the processing load accordingly. On the other hand, whenever a recording start command in the mail voice unit is given, a message indicating recording must be displayed on the LCD or the LED is lighted or blinked in the extension, resulting in waste of power.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram to show the configuration of an exchange system according to a first embodiment;

FIG. 2 is an exemplary schematic sequence chart to show transmission and reception operation of information among a telephone terminal of a caller, a central control section, an extension terminal, a voice mail unit, and a voice message detection section when a call is monitored in the first embodiment;

FIG. 3 is an exemplary detailed sequence chart of FIG. 2;

FIG. 4 is an exemplary flowchart to show the control procedure of the central control section in the first embodiment;

FIG. 5 is an exemplary sequence chart to describe the release operation of a call monitor mode in the first embodiment;

FIG. 6 is an exemplary sequence chart to describe the operation from the call monitor mode to telephone conversation in the first embodiment;

FIG. 7 is an exemplary block diagram to show the configuration of an exchange system according to a second embodiment; and

FIG. 8 is an exemplary flowchart to show the control procedure of a central control section in the second embodiment.

### DETAILED DESCRIPTION

Various embodiments according to the invention will be described hereinafter with reference to the accompanying drawings.

### First Embodiment

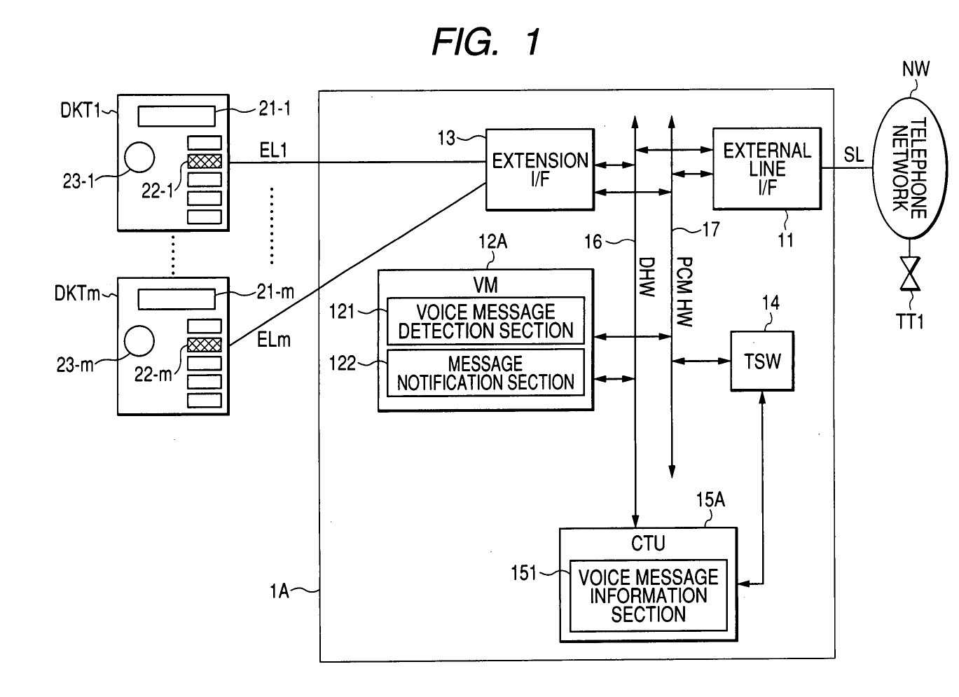

FIG. 1 is an exemplary block diagram to show the configuration of an exchange system according to a first embodiment, and 1A denotes a main unit.

The main unit 1A includes an external line interface section (external line I/F) 11, a voice mail unit (VM) 12A, an extension interface section (extension I/F) 13, a time switch (TSW) 14, and a central control section (CTU) 15A, and the external line interface section 11, the voice mail unit 12A, the extension interface section 13, and the central control section 15A are connected to each other via a control bus (DHW) 16. The external line interface section 11, the voice mail unit 12A, the extension interface section 13, and the time switch 14 are connected to each other via a voice bus (PCM HW) 17.

The external line interface section 11 is connected to a telephone network NW via a subscriber line SL for performing call establishment processing between the system and the telephone network NW, etc.

The extension interface section 13 accommodates a plurality of extensions ELl to ELm, to which extension terminals DKTl to DKTm are connected. For example, digital key telephones are used as the extension terminals DKTl to DKTm. The extension interface section 13 performs incoming and outgoing call processing, transfer processing of digital signals, etc., for the extension terminals DKTl to DKTM. The extension terminals DKTl to DKTm include LCDs 21-l to 21-m, LEDs 22-l to 22-m, and speakers 23-l to 23-m.

The time switch 15 performs channel exchange of a digital signal transmitted via the voice bus 17 among the external line interface section 11, the voice mail unit 12A, and the extension interface section 13 as instructed by the central control section 15A.

The central control section 15A includes an incoming call response control function using the voice mail unit 12A in addition to usual control functions of calling processing accompanying a calling request of each of the extension terminals DKTl to DKTm, usual incoming call processing accompanying an external line incoming call from the subscriber line SL, transfer processing among the extension terminals DKTl to DKTm, and the like. The incoming call response control function performs the following control: When an external line incoming call occurs, before the called extension terminal DKTl is ringed, the voice mail unit 12A is called and the voice mail unit 12A and the external line of the incoming call are connected, whereby a predetermined announcement message is sent to the subscriber line SL.

The voice mail unit 12A has mail boxes provided in a one-to-one correspondence with the extension terminals DKTl to DKTm and stores a voice message from a caller in any mail box.

The voice mail unit 12A of the first embodiment includes a voice message detection section 121 and a message notification section 122. The voice message detection section 121 detects a voice message from a caller in accordance with the announcement message after the voice mail unit 12A and the external line of the incoming call are connected. The message notification section 122 notifies the central control section 15A that the voice message detection section 121 has detected a voice message.

On the other hand, the central control section 15A includes a voice message information section 151. If the voice message of the caller is detected continuously for two seconds, for example, from the voice mail unit 12A, the voice message information section 151 sends data to the effect that the voice message of the caller is being recorded to the extension terminal DKTl, for example, corresponding to the mail box recording the voice message, thereby producing display indicating recording the voice message on the LCD 21-l and the LED 22-l of the extension terminal DKTl and sending a tone indicating recording the voice message from the speaker 23-l.

Next, the operation of the described system will be described.

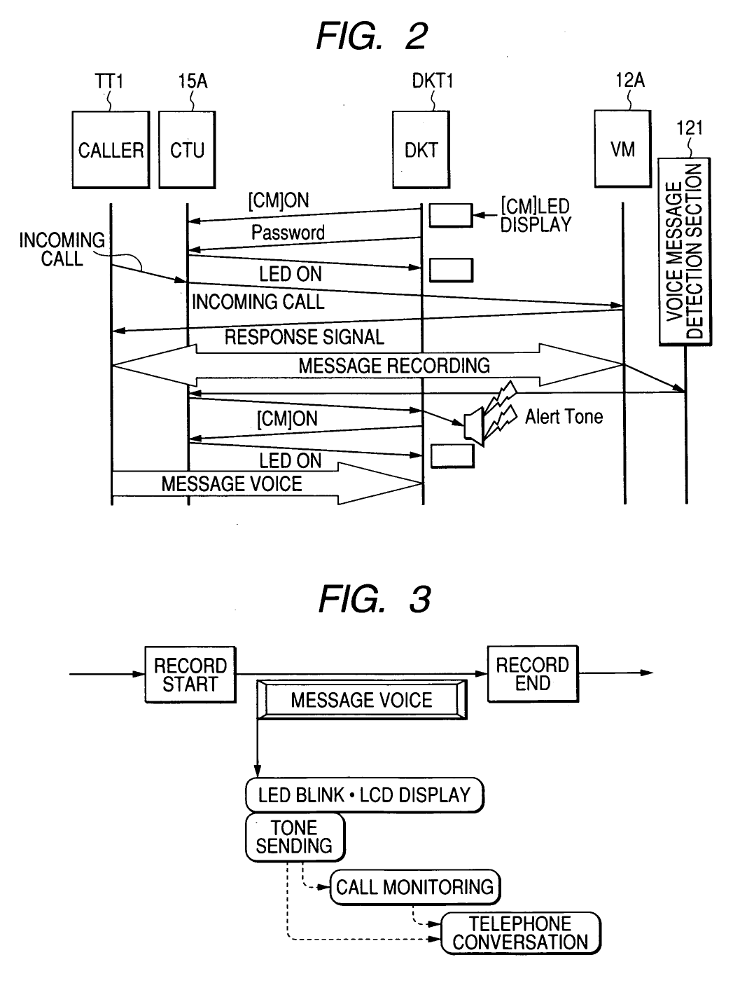

FIG. 2 is an exemplary schematic sequence chart to show transmission and reception operation of information among a telephone terminal TTl of a caller, the central control section 15A, the extension terminal DKTl, the voice mail unit 12A, and the voice message detection section 121 when a call is monitored. FIG. 3 is a detailed sequence chart of FIG. 2.

In order to make setting so as to accept an external line incoming call at the voice mail unit 12A, the user of the extension terminal DKTl, for example, presses a [CM] button of the extension terminal DKTl and enters a password.

Upon reception of a notification that the [CM] button is pressed and the password from the extension terminal DKTl, the central control section 15A sends display data to the effect that the setting is accepted to the extension terminal DKTl, thereby producing display on the LED 22-l of the extension terminal DKTl.

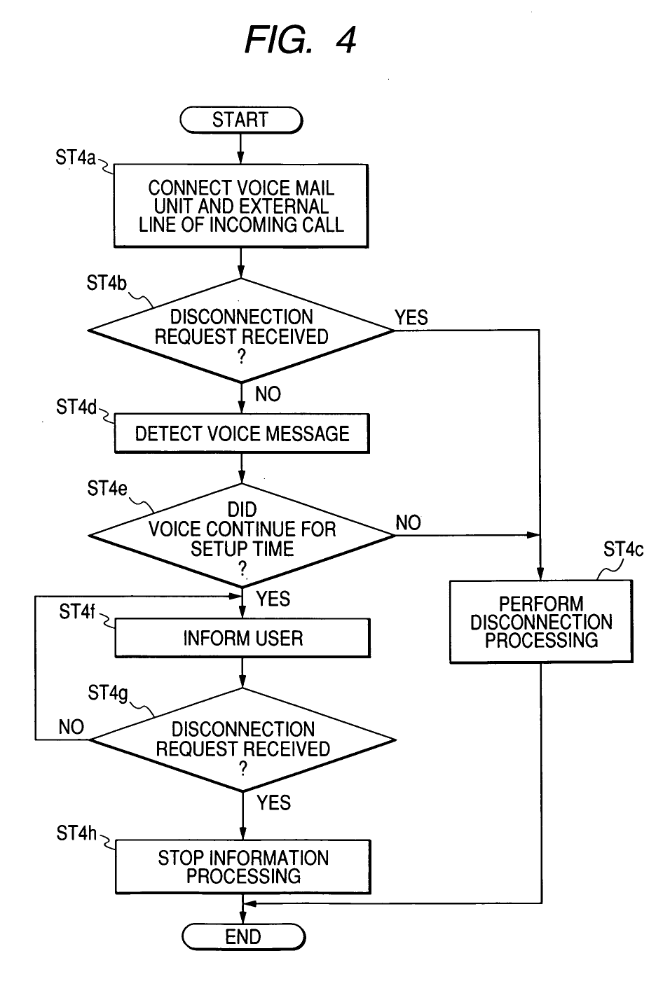

Now assume that an incoming call signal directed to the extension terminal DKTl arrives from an external telephone terminal TTl connected to the telephone network NW, for example. Then, the incoming call signal is detected in the external line interface section 11 and the detection data is transmitted to the central control section 15A via the control bus 16. Then, the central control section 15A starts control processing shown in FIG. 4 and executes incoming call processing for the mail box of the voice mail unit 12A owned by the user of the extension terminal DKTl.

When the incoming call signal arrives, the voice mail unit 12A automatically responds and plays back and sends a previously recorded announcement message. Upon detection of the response of the voice mail unit 12A, the central control section 15A connects the voice mail unit 12A and the external telephone terminal TTl through the time switch 14 to form a communication path (block ST4a). Thus, the announcement message from the voice mail unit 12A is sent to the external telephone terminal TTl.

For example, a message of “Now, I am busy. Please, leave your message after the tone of beep. --Beep--.” is used as the announcement message.

At this time, the central control section 15A monitors arrival of an on-hook signal, namely, a disconnection request from the external telephone terminal TTl (ST4b). If a disconnection request comes (YES at ST4b) , the central control section 15A disconnects the communication path (ST4c); if detection information of a voice message of the caller arrives from the voice mail unit 12A (NO at ST4b), the central control section 15A goes to block ST4d and detects the voice message.

The central control section 15A determines whether or not the detection information from the voice mail unit 12A continues, for example, for two seconds or more (block ST4e). If the detection information continues for less than two seconds (NO at block ST4e), the central control section 15A goes to block ST4c described above; if the detection information continues for two seconds (YES at block ST4e), the central control section 15A sends data to the effect that the voice message of the caller is being recorded to the extension terminal DKTl, for example, corresponding to the mail box recording the voice message, thereby producing display indicating that the voice message is being recorded on the LCD 21-l and the LED 22-l of the extension terminal DKTl and sending a tone indicating that the voice message is being recorded from the speaker 23-l (block ST4f). The tone is sent once at the detection time of the voice message from the caller. Therefore, the information enables the user to know that the voice message from the caller is recorded in the mail box.

In this state, assume that the user presses the [CM] button of the extension terminal DKTl to monitor the call. Then, the voice message from the caller is sent from the speaker 23-l of the extension terminal DKTl.

Assume that the caller places the external telephone terminal TTl on-hook. Then, the central control section 15A detects the on-hook state and goes from block ST4g to block ST4h and stops and terminates information processing of informing the extension terminal DKTl, namely, display on the LCD 21-l and lighting or blinking the LED 22-l.

Releasing call monitor mode

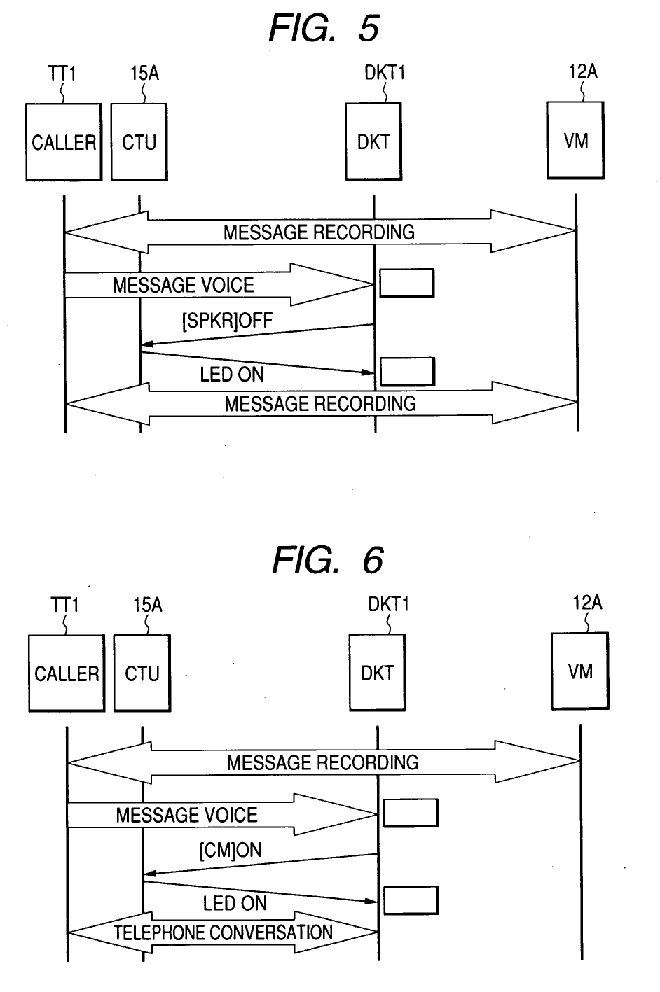

Now, assume that call monitor of the voice message of the caller is executed in the extension terminal DKTl, for example, as shown in FIG. 5.

In this state, assume that the user presses a [SPKR] button of the extension terminal DKTl. Then, a release request signal is sent from the extension terminal DKTl to the central control section 15A. Upon reception of the release request signal, the central control section 15A releases the call monitor mode of the extension terminal DKTl, thereby restoring the mode to a record mode in the voice mail unit 12A.

Operation from call monitor mode to telephone conversation

Now, assume that call monitor of the voice message of the caller is executed in the extension terminal DKTl, for example, as shown in FIG. 6.

In this state, assume that the user presses the [CM] button of the extension terminal DKTl. Then, a communication establishment request signal is sent from the extension terminal DKTl to the central control section 15A. Upon reception of the communication establishment request signal, the central control section 15A connects the extension terminal DKTl and the held communication path of the external telephone terminal TTl with the communication path with the external telephone terminal TTl held.

Thus, the party with which the external telephone terminal TTl communicates is changed from the voice mail unit 12A to the extension terminal DKTl and after this, it is made possible for the user of the external telephone terminal TTl to hold a conversation with the user of the extension terminal DKTl.

As described above, in the first embodiment, when an incoming call directed to the extension terminal DKTl arrives from the external telephone terminal TTl and the incoming call signal is transferred to the voice mail unit 12A, the voice message detection section 121 of the voice mail unit 12A detects the presence or absence of a voice message from the caller before the extension terminal DKTl is notified that recording of the voice message from the caller is started. If the voice message from the caller is detected, the central control section 15A informs the extension terminal DKTl that the voice message is detected.

Therefore, a notification that the voice message of the caller is recorded can be provided reliably and appropriately for the corresponding one of the extension terminals DKTl to DKTm, so that the processing load on the central control section 15A such that display indicating recording is produced on the LCD 21-l to the LCD 21-m and the LED 22-l to the LED 22-m although no voice message exists can be kept to a minimum, and the power consumption of each of the extension terminals DKTl to DKTm can be kept to a minimum.

In the first embodiment described above, when the voice message from the caller is detected continuously for a predetermined time in the voice mail unit 12A, the extension terminal DKTl is informed that the voice message from the caller is detected, so that the voice message from the caller can always be detected reliably.

In the first embodiment described above, information to the effect that the voice message from the caller is being recorded in the voice mail unit 12A is displayed on the LCD 21-l and the LED 22-l of the extension terminal DKTl and the tone indicating that the voice message is being recorded is also sent from the speaker 23-l, so that if the user does not face the extension terminal DKTl, for example, the tone enables the user to know that the voice message is recorded.

### Second Embodiment

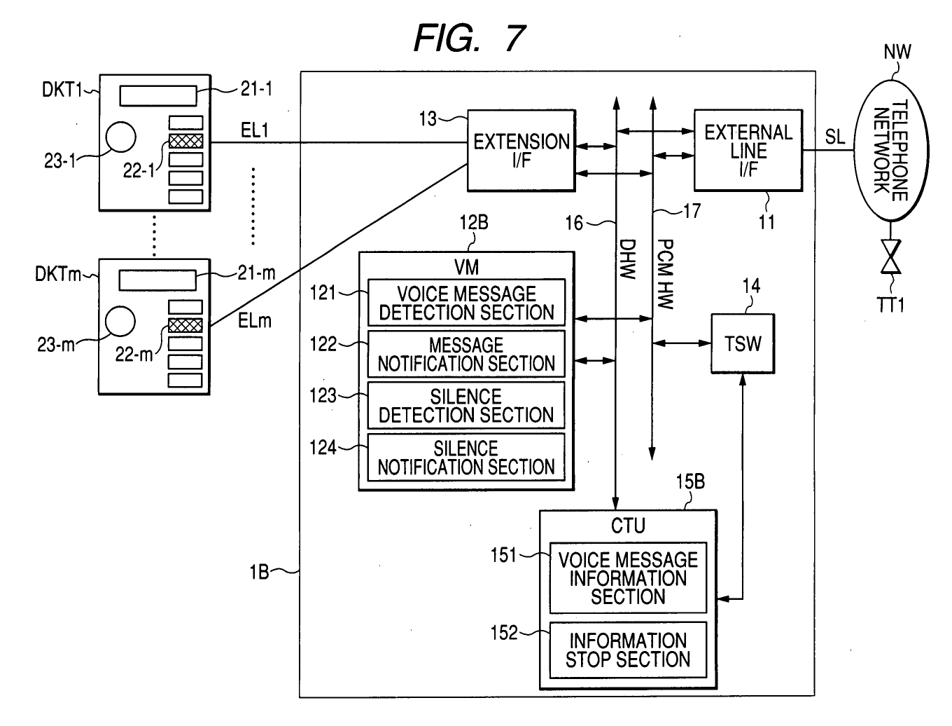

FIG. 7 is an exemplary block diagram to show the configuration of an exchange system according to a second embodiment, and 1B denotes a main unit.

A voice mail unit 12B differs from the voice mail unit 12A in that it further includes a silence detection section 123 and a silence notification section 124. The silence detection section 123 detects silence, for example, for five seconds or more while a voice message from a caller is being recorded. The silence notification section 124 sends silence detection information provided by the silence detection section 123 to a central control section 15B.

The central control section 15B differs from the central control section 15A in that it further includes an information stop section 152. The information stop section 152 stops display processing indicating that a voice message is being recorded on an extension terminal DKTl involved in the operation.

Next, the operation of the described system will be described.

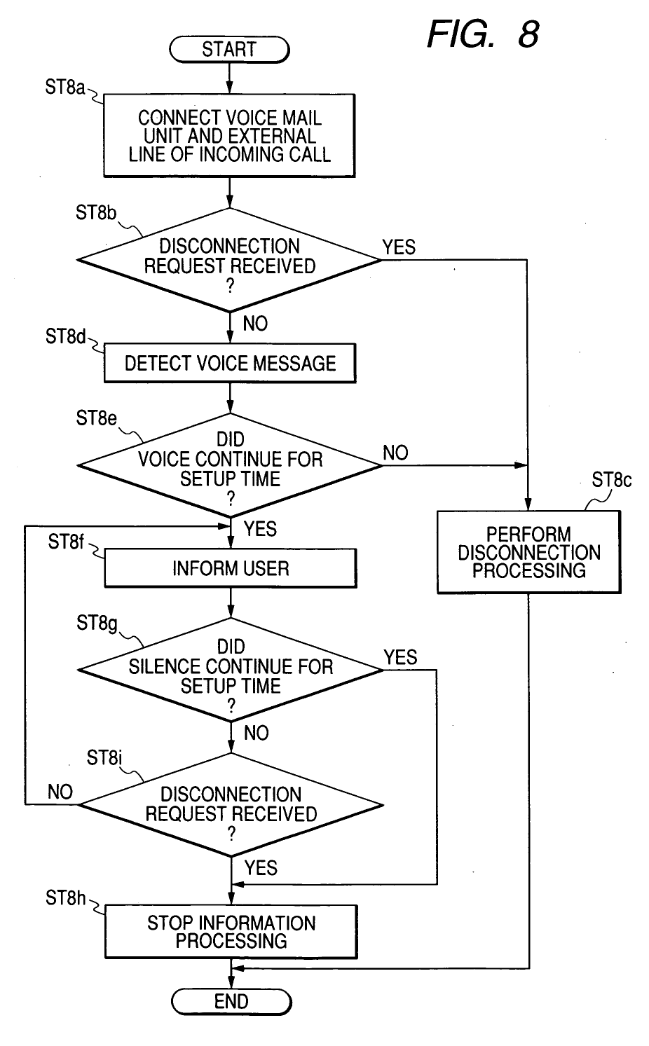

Now assume that an incoming call signal directed to the extension terminal DKTl arrives from an external telephone terminal TTl connected to a telephone network NW, for example. Then, the incoming call signal is detected in an external line interface section 11 and the detection data is transmitted to the central control section 15B via a control bus 16. Then, the central control section 15B starts control processing shown in FIG. 8 and executes incoming call processing for the mail box of the voice mail unit 12B owned by the user of the extension terminal DKTl.

When the incoming call signal arrives, the voice mail unit 12B automatically responds and plays back and sends a previously recorded announcement message. Upon detection of the response of the voice mail unit 12B, the central control section 15B connects the voice mail unit 12B and the external telephone terminal TTl through a time switch 14 to form a communication path (block ST8a). Thus, the announcement message from the voice mail unit 12B is sent to the external telephone terminal TTl.

At this time, the central control section 15B monitors arrival of an on-hook signal, namely, a disconnection request from the external telephone terminal TTl (ST8b). If a disconnection request comes (YES at ST8b), the central control section 15B disconnects the communication path (ST8c); if detection information of a voice message of the caller arrives from the voice mail unit 12B (NO at ST8b), the central control section 15B goes to block ST8d and detects the voice message.

The central control section 15B determines whether or not the detection information from the voice mail unit 12B continues, for example, for two seconds or more (block ST8e). If the detection information continues for less than two seconds (NO at block ST8e), the central control section 15B goes to block ST8c described above; if the detection information continues for two seconds (YES at block ST8e), the central control section 15B sends data to the effect that the voice message of the caller is being recorded to the extension terminal DKTl, for example, corresponding to the mail box recording the voice message, thereby producing display indicating that the voice message is being recorded on an LCD 21-l and an LED 22-l of the extension terminal DKTl and sending a tone indicating that the voice message is being recorded from a speaker 23-l (block ST8f). Therefore, the information enables the user to know that the voice message from the caller is recorded in the mail box.

The central control section 15B monitors arrival of silence detection information from the voicemail unit 12B while the voice message is being recorded (block ST8g). If silence is detected, for example, for five seconds or more (YES at block ST8g), the central control section 15B goes to block ST8h and stops and terminates information processing of informing the extension terminal DKTl, namely, display on the LCD 21-l and lighting or blinking the LED 22-l.

On the other hand, if silence is not detected at block ST8g and the caller places the external telephone terminal TTl on-hook, the central control section 15B goes from block ST8g to block ST8i and detects the on-hook state and goes to block ST8h.

As described above, in the second embodiment, if silence is detected for five seconds or more while the voice message from the caller is being recorded in the voice mail unit 12B before voice message record termination processing, namely, detection of the on-hook state of the external telephone terminal TTl of the caller, information processing of informing the extension terminal DKTl, namely, display on the LCD 21-l and lighting or blinking the LED 22-l are stopped.

Therefore, the information processing indicating that the voice message is recorded can be stopped reliably and the power consumption of the extension terminal DKTl can be decreased as the information processing can be stopped earlier than the voice message record termination processing.

### OTHER EMBODIMENTS

The invention is not limited to the specific embodiments described above. In the description of the first embodiment, a tone is sent once to the extension terminal corresponding to the mail box at the detection time of the voice message from the caller by way of example. However, the invention is not limited to the mode. For example, a tone may be sent at intervals of 10 seconds as the setup time. In doing so, if the user fails to hear the tone at the detection time of the voice message, the tone sent at the setup time intervals enables the user to know that the voice message is recorded.

In the description of the first embodiment, the user is informed that the voice message is detected by producing a tone and display on the LCD and the LED of the extension terminal by way of example. However, the invention is not limited to the mode. Only one of the tone and the display on the LCD and the LED of the extension terminal may be adopted in accordance with a selection command of the user.

In the description of the first embodiment, the voice mail unit has the mail boxes provided in a one-to-one correspondence with the extension terminals by way of example, but may include a mail box corresponding to an external telephone terminal other than the extension terminals.

In the description of the first embodiment, the voice mail unit is contained in the main unit by way of example, but may be attached to any other place than the main unit.

In addition, the system configuration and type, the main unit configuration, the extension terminal type, the control procedure of the information control of the voice message etc., can also be modified in various manners without departing from the spirit and the scope of the invention.

It is to be understood that the present invention is not limited to the specific embodiment described above and that the present invention can be embodied with the components modified without departing from the spirit and scope of the invention. The present invention can be embodied in various forms according to appropriate combinations of the components disclosed in the embodiment described above. For example, some components may be deleted from all components shown in the embodiment. Further, the components in different embodiments may be used appropriately in combination.

What is claimed is:

1. An exchange system comprising:
a telephone exchange apparatus that accommodates a plurality of extensions to which telephone terminals are connected, and connects the telephone exchange apparatus to an external line; and
a voice storage unit that is connected to the telephone exchange apparatus, responds to an incoming call through the telephone exchange apparatus, and stores a voice message sent from the calling telephone terminal in a mail box provided fro each of the telephone terminals,
wherein the voice storage unit comprises:
a detection unit the detects the voice message sent from the calling telephone terminal after connection to the calling telephone terminal; and
an information unit that, when the voice message is detected, sends detection information to the telephone exchange apparatus, the detection information informing the detection of the voice message, and
wherein the telephone exchange apparatus comprises a notification unit that notifies the detection of the voice message to the telephone terminal corresponding to the mail box in which the voice message is detected when the detection information is received from the voice storage unit.

2. The exchange system according to claim 1, wherein the notification unit notifies the detection of the voice message to the telephone terminal corresponding to the mail box in which the voice message is detected when the voice storage unit detects the voice message continuously for a predetermined time period.

3. The exchange system according to claim 1, wherein the notification unit notifies to the telephone terminal to display the detection of the voice message.

4. The exchange system according to claim 1, wherein the notification unit notifies to the telephone terminal to output a tone indicating the detection of the voice message.

5. The exchange system according to claim 4, wherein the notification unit notifies to the telephone terminal to output the tone when the voice storage unit detects the voice message.

6. The exchange system according to claim 4, wherein the notification unit notifies to the telephone terminal to output the tome at a predetermined time intervals.

7. The exchange system according to claim 1, wherein the voice storage unit further comprises:
a silence detection unit that detects silence continuing for a predetermined time or more; and
a silence information unit that sends silence information to the telephone exchange apparatus, the silence information informing the detection of the silence, and
wherein the telephone exchange apparatus further comprises a stop unit that stops notifying the telephone terminal by the notification unit when the silence information is received from the voice storage unit.

8. A telephone exchange apparatus comprising:
a plurality of extensions to which telephone terminals are connected; and
a connector that connects an external line to which the telephone terminals are connected through the extensions,
wherein the telephone exchange apparatus is configured to be connectable with a voice storage unit that responds to an incoming call through the telephone exchange apparatus, and stores a voice message sent from the calling telephone terminal in a mail box provided fro each of the telephone terminals, and
wherein the telephone exchange apparatus further comprises a notification unit that notifies the detection of the voice message to the telephone terminal corresponding to the mail box in which the voice message is detected when the detection information is received from the voice storage unit.

9. The telephone exchange apparatus according to claim 8, further comprising a stop unit that stops notifying the telephone terminal by the notification unit when silence information is received from the voice storage unit, the silence information informing a detection of silence continuing for a predetermined time or more.

10. A method for notifying a voice message used with an exchange system including:
a telephone exchange apparatus that accommodates a plurality of extensions to which telephone terminals are connected, and connects the telephone exchange apparatus to an external line; and
a voice storage unit that is connected to the telephone exchange apparatus, responds to an incoming call through the telephone exchange apparatus, and stores a voice message sent from the calling telephone terminal in a mail box provided fro each of the telephone terminals,
wherein the method comprising:
detecting by the voice storage unit the voice message sent from the calling telephone terminal after connection to the calling telephone terminal;
informing detection information to the telephone exchange apparatus when the voice message is detected, the detection information informing the detection of the voice message; and
notifying by the telephone exchange apparatus the detection of the voice message to the telephone terminal corresponding to the mail box in which the voice message is detected when the detection information is received from the voice storage unit.
